(19) United States
(12) Patent Application Publication
(10) Pub. No.: US 2008/0120264 A1
(43) Pub. Date: May 22, 2008

(54) Method and Apparatus for Efficient Spectrum Management in a Communications Network

(75) Inventors: Whay Chiou Lee, Cambridge, MA (US); Charbel Khawand, Miami, FL (US); Kevin L. Kloker, Palatine, IL (US); Stephen N. Levine, Itasca, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/561,491

(22) Filed: Nov. 20, 2006

(51) Int. Cl. G06F 17/00

(52) U.S. Cl. 706/47

(57) ABSTRACT

A method and apparatus for efficient management of hierarchically administered spectrum resources in a communications network are disclosed. The method may include receiving a request for a policy decision from a policy enforcement point at a current policy decision point level in a hierarchy of policy decision points, determining whether the request can be satisfied at the current policy decision point level, wherein if the request cannot be satisfied at the current policy decision point level, forwarding the request to a policy decision point at a policy decision point level that is higher in the hierarchy, otherwise retrieving policy information from a policy database, determining a policy decision, wherein if the request was received from the policy enforcement point at the current policy decision point hierarchy level, sending the policy decision to the policy enforcement point at the current policy decision point level in the hierarchy, otherwise, sending the policy decision to a policy decision point level lower in the hierarchy.

### BACKGROUND OF THE INVENTION

1. Field of the Invention

The present invention relates to allocation of spectrum in a communications network.

2. Introduction

A cognitive radio (CR) is a technology that enables a wireless network or the nodes therein to share spectral resources efficiently by changing selected operating parameters, such as transmission and reception parameters. In particular, unlicensed users may employ CR technology to effectively utilize idle spectrum without interfering with licensed users. Parameter alteration to enable such opportunistic spectrum access is based on appropriate observable context, such as radio frequency spectrum, user profile, network state, etc. CR-based dynamic spectrum allocation is typically supported by software defined radio (SDR), which is a radio communication system that uses software for modulation and demodulation radio signals.

There are a number of technical challenges for dynamic spectrum allocation. For example, spectral pollution may be caused by wireless users, dynamic and unpredictable propagation characteristics may exist in the network, or users may attempt to access the network using heterogeneous radio systems.

### SUMMARY OF THE INVENTION

A method and apparatus for efficient management of hierarchically administered spectrum resources in a communications network are disclosed. The method may include receiving a request for a policy decision from a policy enforcement point at a current policy decision point level in a hierarchy of policy decision points, determining whether the request can be satisfied at the current policy decision point level, wherein if the request cannot be satisfied at the current policy decision point level, forwarding the request to a policy decision point at a policy decision point level that is higher in the hierarchy, otherwise retrieving policy information from a policy database, determining a policy decision, wherein if the request was received from the policy enforcement point at the current policy decision point hierarchy level, sending the policy decision to the policy enforcement point at the current policy decision point level in the hierarchy, otherwise, sending the policy decision to a policy decision point level lower in the hierarchy.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a spectrum block in a communications network in accordance with a possible embodiment of the invention;

FIG. 2 illustrates an exemplary diagram of a spectrum block hierarchy in a communications network in accordance with a possible embodiment of the invention;

FIG. 3 illustrates a block diagram of an exemplary policy decision point hierarchy in accordance with a possible embodiment of the invention;

FIG. 4 illustrates an exemplary block diagram of a policy decision point in accordance with a possible embodiment of the invention; and

FIG. 5 is an exemplary flowchart illustrating one possible hierarchical policy decision process in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method and apparatus and other embodiments that relate to the basic concepts of the invention.

This invention concerns a method and apparatus for efficient management of a communications spectrum using cognitive radio technology, wherein appropriate context information (e.g., user profiles, environmental conditions, etc.) may be learned by a plurality of wireless devices and used to adapt predetermined operating parameters (e.g., access protocol, modulation, power control, etc.) to improve efficiency of spectrum utilization. Such a method may allow users to dynamically and efficiently share spectrum resources in accordance with a predetermined policy, which comprises a set of predefined policy rules. A mechanism may be used to distribute, manage, and enforce policy rules that are used for dynamic spectrum management.

One of the existing problems in such conventional policy systems are its complexity due to a variety of factors, such as administrative division of the spectrum block, diverse user profiles associated with radios of varying capabilities, and a highly dynamic environment caused by mobility and changing population of users. A need remains to reduce the complexity of such policy systems while ensuring consistent implementation of policy rules.

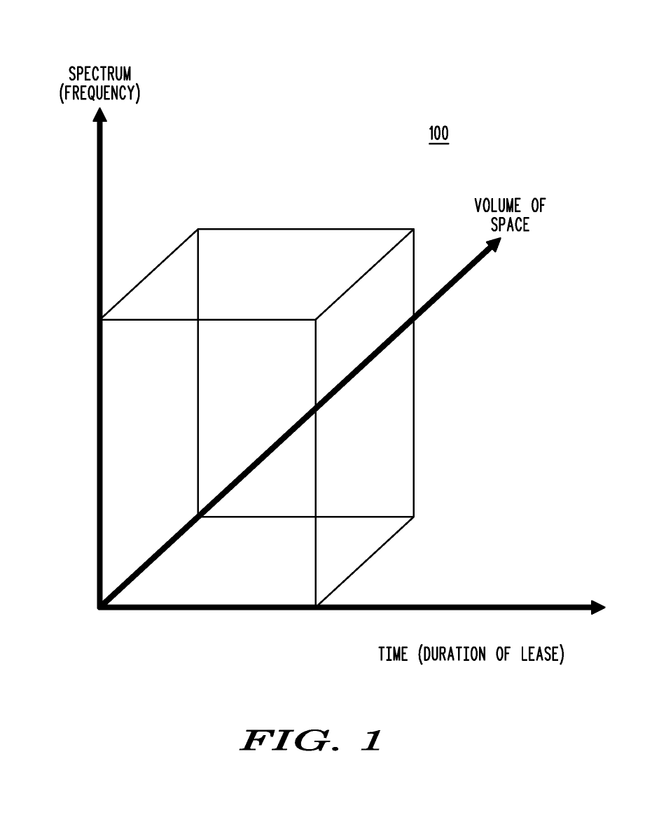

FIG. 1 illustrates an exemplary diagram of a spectrum block 100 in accordance with a possible embodiment of the invention. Radio frequency authorization is traditionally an assignment of spectrum(s) over a volume (v) of space for duration of time (t), as illustrated by the three axes. This unit of resource is often referred to as a spectrum block 100. A spectrum is more efficiently utilized when each spectrum block 100 can be dynamically shared (in short-term and real-time on an instant-by-instant basis) among a plurality of users. Opportunistic spectrum access in a manner that limits interference to primary users is made possible for policy-based adaptive radio.

Spectrum leasing can be managed centrally or in a distributed manner geographically, bureaucratically, etc.). For example, a government may divide a spectrum block 100 into non-overlapping sub-blocks and offer licenses that give their recipients exclusive right to transmit in the sub-blocks respectively. Alternatively, no licenses may be granted and anyone who wishes to transmit in the spectrum block 100 may do so subject to predetermined policy-based restrictions that are imposed on access protocols to facilitate coexistence.

Where spectral resources are allocated exclusively, there may be no mutual interference. However, such exclusive allocation is inefficient because idle resources in a sub-block may be wasted. On the other hand, where spectral resources are dynamically shared in a coordinated manner, allocated spectral resources can be reused efficiently.

To enable dynamic spectrum allocation, all transmissions in a spectrum block 100 may be coordinated to minimize mutual interference. Each transceiver may be equipped with capability for environment sensing (e.g., measuring interference, estimating channel quality, etc.), adaptive access control (e.g., power control), and policy enforcement.

Admission control is a function of constraining the number and types of communication sessions that are allowed to be active in a spectrum block 100, such that admitted sessions can be assured their respective desired level of quality of service. In policy-based admission control, policy rules governing sharing of a given spectrum block 100 are established a priori between an owner and all users of the spectrum block 100. Policy rules are used to evaluate admission requests from a user, based on its user profile and prevailing environmental factors, to determine if the user is allowed to use a particular spectrum block 100.

All users are expected to honor policy rules governing sharing of a spectrum block 100. In particular, upon admission, a user must accept a service level governed by operating parameters determined by the policy rules. Primary users of a spectrum block 100 are normally granted priority access of the spectrum block 100 over secondary users. However, exceptions can be made for selected secondary users (e.g., a regulator may require primary users to be preempted when first responders need to use a spectrum block 100 for responding to an incident).

A user profile may be utilized in the spectrum block 100 and is a set of parameters characterizing a specific user or a class of users. These parameters may include predetermined static information such as identity, affiliation, billing, processing capacity, etc. They may also include dynamic information such as offered load, location, speed of movement, available power, modulation parameters, operational frequency range, codec capabilities, user priority, etc.

During call setup requested by a user, a call manager typically employs a signaling protocol to obtain the user profile of the user. The information contained in the user profile can be preconfigured, provided by the user at call setup, or derived from characteristics of the user's device interface.

Given a spectrum block 100, there exist a variety of environmental factors that could dynamically modify the properties of resources available in the spectrum block 100. Specifically, due to these environmental factors, the effective capacity of the spectrum block 100 can vary in spatial-temporal dimensions. For example, the achievable data rate of a wireless channel is often time-varying due to a variety of channel impairments and interference. In a communication system utilizing policy-based admission control, environmental factors can be taken into consideration for making decisions regarding admissibility of incoming calls.

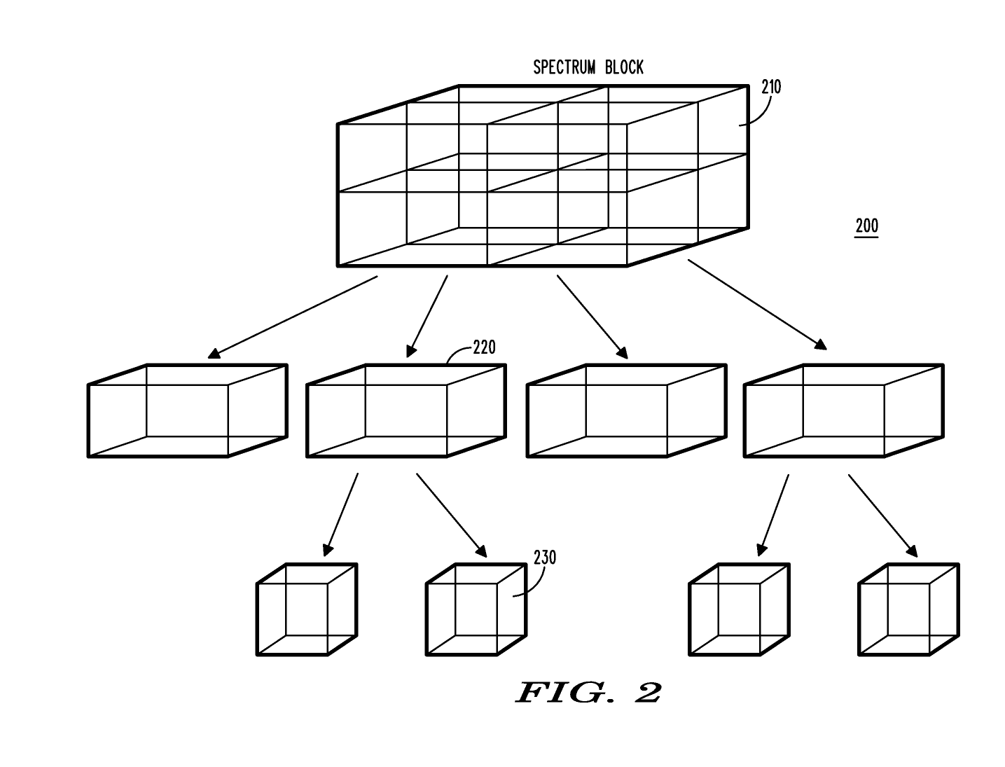

FIG. 2 shows an exemplary block diagram of a spectrum block hierarchy 200 in accordance with a possible embodiment of the invention. The spectrum block 210 is hierarchically divided into smaller spectrum blocks 220 and 230, in dimensions of space, frequency, time, or combinations thereof. Each spectrum block 210, 220, 230 at a level can be a unit for allocation or lease to a user or a class of users. Allocation of resources in a spectrum block 210, 220, 230 at a given level is governed by a predetermined set of policy rules.

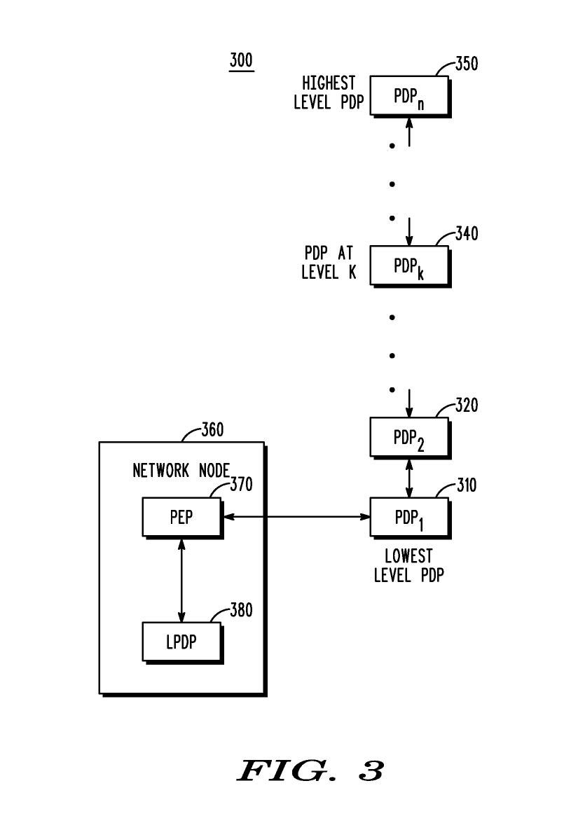

FIG. 3 illustrates an exemplary policy decision point hierarchy 300 in accordance with a possible embodiment of the invention. Specifically, the hierarchy 300 may include a network node 360 that contains a policy enforcement point (PEP) 370 and a local policy decision point (LPDP) 380. The PEP 370 is connected to a policy decision point PDP) 310. As an example in this diagram, the PDP 310 is shown as the lowest level PDP in the hierarchy 300. The diagram illustrates that there maybe a plurality of PDP levels 310, 320, 330, 340 in the hierarchy. The highest level PDP 350 may be located at the system policy server, for example. In an embodiment, PDPs at different levels in the hierarchy may be physically located at different devices, including the system policy server. In another embodiment, PDPs at different levels in the hierarchy may be physically co-located.

A PDP 310 is an entity that is responsible for maintaining a set of policy rules, and using them to make selected resource allocation decisions. The PDP 310 may make use of additional mechanisms and protocols to achieve additional functionality such as user authentication, accounting, policy information storage, etc. A PEP 370 is an entity that is responsible for implementing policy decisions made by a PDP 310. An LPDP 380 is an entity that is used to maintain locally significant policy rules and to cache policy decisions locally to improve response time.

Upon receiving a policy request, a PEP 370 may use an LPDP 380 to reach a local decision, if one is available. This partial decision and the original policy request are then forwarded to PDP 310 to render a final decision, which is returned to the PEP 370. Where an LPDP 380 is not available, the PEP 370 submits the policy request directly to the PDP 310, which will return a policy decision. The PEP 370 may cache the policy decision in the LPDP 380 for future use.

A policy defines a set of rules or principles, which govern how predetermined resources are allocated under variable network and load conditions. A policy rule comprises a condition clause and an action clause, wherein if the condition clause evaluates to TRUE, then a set of predetermined actions (specified in the action clause) can be executed. More than one action may be triggered by a common set of conditions. A policy action typically defines a step of setting or resetting the value of a control parameter associated with resource allocation.

Policy rules can be organized in hierarchical groups. A policy group (or folder) contains policy rules and/or policy groups. Policy rules and policy groups may be nested within other policy rules, providing a hierarchical policy definition. Hierarchical policy rule definitions enhance policy readability and reusability.

Policy control in a large network may be applied to minimize performance overhead associated with different mechanisms that provide traffic and route filtering, bandwidth control, routing policy, congestion management, and differentiated classes of service. Greater impact on network performance may be attained when policy control is implemented in higher levels of the network hierarchy due to higher speed of inter-nodal connectivity. In this respect, policy implementation in large networks may be pushed out to the network periphery as much as possible to maintain stability in the core network.

As shown in the FIGS. above, one of the aspects of the invention is a scalable policy system for managing a spectrum block 210 with wireless or cognitive radio, wherein the spectrum block 210 is hierarchically structured, such that a spectrum block 210, 220, 230 at a given level, except the lowest level, is an aggregation of a plurality of spectrum blocks at the next lower level. In accordance with the invention, a policy management system is used, wherein PDPs 310-350 are structured hierarchically, such that the PDP hierarchy 300 matches that of the spectrum block hierarchy 200, and a PDP 310-350 at a given level governs the allocation of resources in a spectrum block 210-230 at a corresponding level.

In addition, a PEP 370 is located in each device equipped with capability to access resources in the spectrum block 210 subject to predetermined admission control policy rules. These policy rules are used by individual PEPs 370 to adapt predetermined operating parameters for dynamic spectrum management in accordance with user profiles and current operating environment. PDPs 310-350 at a given level coordinate among themselves and with their parent PDP at the next higher level to ensure consistency of policy decisions that are consistent with selected user profiles.

Each PDP 310-350 at a given level aggregates user profiles to improve scalability. Specifically, user profiles are aggregated as they propagate up the PDP hierarchy 300, such that user profiles at higher levels apply to larger user communities. Policy decisions associated with a multi-user session, wherein different user profiles are submitted, are consolidated to accommodate all users in the session. Specifically, conflicting policy decisions are consolidated based on a lowest common denominator to accommodate all users associated with the user profiles. In an embodiment, policy updates begin at the highest level PDP 350 and trickle down the PDP hierarchy 300 to the lowest level PDP 310, for example.

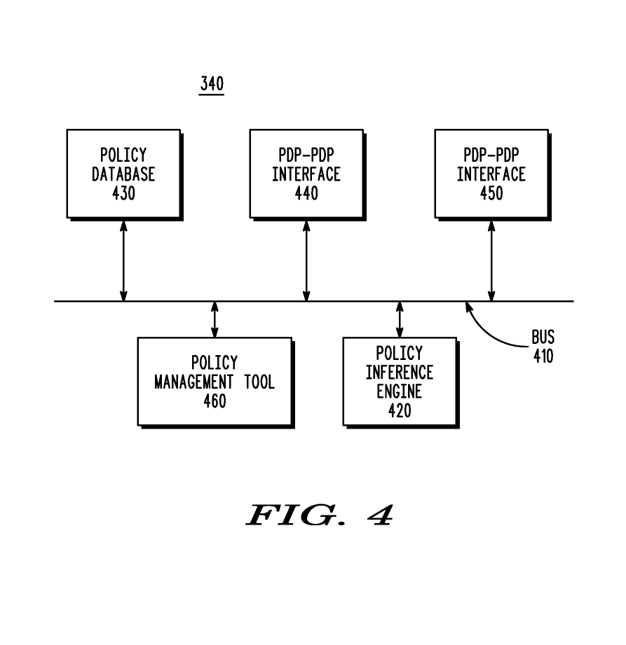

FIG. 4 illustrates an exemplary policy decision point 310 in accordance with a possible embodiment of the invention. As shown in FIG. 3, PDPs 310-350 are structured hierarchically, such that the PDP hierarchy 300 matches that of the spectrum block hierarchy 200. A PDP 310 at a given level governs the allocation of resources in a spectrum block at a corresponding level. Such hierarchical structure improves scalability of policy-based dynamic spectrum allocation. When requested resources are limited to a spectrum block at a given level, a PDP 310 at the corresponding level is consulted. When requested resources span beyond a spectrum block at a given level, a higher level PDP 320-350 will be consulted.

In that regard, a PDP 340 at a given level, say at level k shown in FIG. 3, may include a bus 410, a policy inference engine 420, a policy database 430, a PDP-PDP interface 440, a PDP-PEP interface 450, and a policy management tool 460. The bus 410 may permit communication among the components of the policy decision point 340.

The policy management tool 460 provides a system administrator with an interface to define, input and modify policies at the appropriate hierarchy level. Whenever there is a policy change (e.g., due to introduction of a new standard or protocol), the information will come from a PDP 310-350 at a particular level, and then trickle down to PDPs 310-340 at lower levels.

The policy database 430 stores policy information pertaining to a spectrum block 210-230 associated with the PDP 310-350 at the appropriate level. This policy information includes policy rules and consolidated user profiles that can be retrieved on demand. While the policy database 430 is shown to be internal to the PDP 340, one of skill in the art will appreciate that the policy database 430 may also be located external to the PDP 340.

The policy inference engine 420 is responsible for making policy-based decisions for spectral resource allocation at the appropriate level. The PDP-PDP interface 440 is used by the PDP 340 to communicate with other PDPs 310, 320, 330, 350 vertically and horizontally across the PDP hierarchy 300. PDPs at different levels of the PDP hierarchy may communicate vertically to pass a request for policy decision up the PDP hierarchy or to pass a policy update down the PDP hierarchy. PDPs with a common parent PDP may communicate horizontally to exchange policy rules or user profiles. The PDP-PEP interface 450 allows the PDP 340 to communicate with any PEP 370 requesting resources in the spectrum block 210-230 governed by the PDP 340.

The policy inference engine 420 may include at least one conventional processor or microprocessor that interprets and executes instructions. Policy database 430 may be stored in a random access memory (RAM or another type of dynamic storage device that stores information and instructions for execution by processor 320, a ROM device or another type of static storage device that stores static information and instructions for policy inference engine 420. The policy database 430 may also be stored using any computer-readable media storage device known to one of skill in the art, including any type of media, such as, for example, magnetic or optical recording media and its corresponding drive.

One of skill in the art may appreciate that the policy decision point 310-350 may be a portion of or located in a cognitive radio, a wireless device, a computer device, a server, etc., or any other device that may implement or provide communications policy decisions.

While not shown, the policy decision point 340 may include an input device, such as one or more conventional mechanisms that permit a user to input information (e.g., a keyboard, a mouse, a pen, a voice recognition device, etc.), an output device such as one or more conventional mechanisms that output information to the user (e.g., a display, a printer, one or more speakers, or a medium, such as a memory, or a magnetic or optical disk and a corresponding disk drive), a communication interface 380 such as a transceiver-like mechanism that enables the policy decision point 340 to communicate via a network (e.g., a modem, an Ethernet interface for communicating via a local area network (LAN), a wireless interface or other devices and/or systems via wired, wireless or optical connections, etc.).

Embodiments may also be practiced in distributed communication environment where tasks are performed by local and remote processing devices that are linked (either by hardwired links, wireless links, or by a combination thereof through a communications network. In a distributed communications environment, program modules may be located in both local and remote memory storage devices.

A user profile associated with a user is provided to the proposed policy system in a bottom-up manner. Upon entry to the network, a user allows a PEP 370 to submit a corresponding user profile to the lowest level PDP 310 associated with the PEP 370. This user profile propagates up the hierarchy of PDPs 320-350. User profiles may be cached by PDP 310-350 at each level for future use. By caching user profiles, a PDP 310-350 can speed up call setup.

To reduce complexity, user profiles are aggregated as they propagate up the PDP hierarchy 300, such that user profiles at higher levels apply to larger user communities. First, user profiles at a given level can be aggregated if all non-common attributes are determined to be unimportant (i.e., can be ignored subject to an acceptable level of performance compromise) for policy decision at the given level. This reduces the number of user profiles maintained by each PDP 310-350, especially one that is high in the PDP hierarchy 300. Second, a plurality of common attributes in similar user profiles can be mapped to a summarized attribute. This reduces the number of attributes per user profile.

Policy rules are used by PDPs 310-350 to determine how PEPs 370 should adapt predetermined operating parameters for dynamic spectrum management in accordance with appropriate user profiles. Where a plurality of PEPs 370 are submitting different user profiles for a common session, the policy decisions (specifically operating parameters), if different, are consolidated based on a lowest common denominator to accommodate all users associated with the user profiles. For example, different user profiles may each provide an operational frequency range, modulation parameters, processing capability, codec capability, etc. The policy decision would determine the channel, modulation, codec, and processing limits so as to enable all users to join the common session. If a few users have limited capabilities that would compromise the quality of the session for the majority, then these users may be rejected from joining the session, unless they are high priority users.

In conventional policy architecture, the PDP may be considered basically a policy server that is responsible for maintaining a predetermined set of policy rules, and using them to make selected resource allocation decisions. Whenever there is any change to the set of policy rules (e.g., due to a change in networking standard or protocol), the PDP must have its database updated to reflect the change.

However, with hierarchical PDPs 310-350 as described herein, a policy change could affect a plurality of PDPs 310-350 at different levels. In accordance with an aspect of the invention, policy updates may begin at the highest level PDP 350 and trickle down the PDP hierarchy 300 to the lowest level PDP 310, for example. Specifically, appropriate control messages are passed down from the highest level PDP 350 to its descendant PDPs 310-340 that are affected by the policy change. Those descendant PDPs 310-340 execute the same procedure until all affected PDPs 310-340 have their databases updated.

This method of updating ensures that all affected PDPs 310-340 are updated efficiently. To ensure secure communication across PDP levels, PDPs 310-350 at different levels must establish trust among themselves using a predetermined authentication protocol, for example.

For illustrative purposes, the process will be described below in relation to the diagrams shown in FIGS. 1-4.

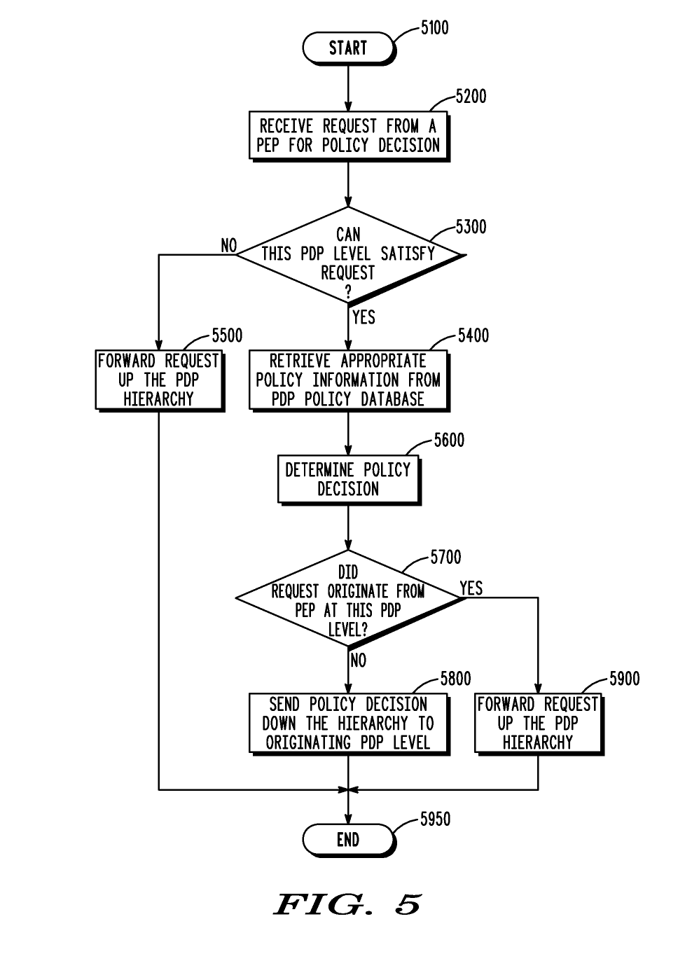

FIG. 5 is an exemplary flowchart illustrating some of the basic steps associated with a spectrum management process in accordance with a possible embodiment of the invention. The process begins at step 5100 and continues to step 5200 where the policy decision point 340 receives a request from a PEP 370 for a policy decision, such as spectrum resource allocation decision. At step 5300, the PDP 340 determines if it can satisfy the request. If the PDP 340 cannot satisfy the request, then at step 5500, the PDP 340 forwards the request up the PDP hierarchy 300. The process then goes to step 5950 and ends.

If the PDP 340 determines that the request can be satisfied at the current PDP level, then at step 5400, the PDP 340 retrieves the appropriate policy information from the PDP policy database 430. At step 5600, the PDP 340 determines the appropriate policy decision.

At step 5700, the PDP 340 determines if the request originated from the PEP 370 at the current PDP hierarchy level. If the PDP 340 determines that the request originated from the PEP 370 at the current PDP hierarchy level, the PDP 340 sends the policy decision to the PEP 370 on the current PDP level. The process then goes to step 5950 and ends. If the PDP determines that the request originated from a PEP 370 at another PDP hierarchy level, the PDP 340 sends the policy decision down the hierarchy 300 to the originating PDP level. The process then goes to step 5950 and ends. While not shown in FIG. 5, upon receiving a policy decision from a parent PDP, a PDP at the current PDP level executes a step similar to step 5700, following thereafter by one of steps similar to steps 5800 and 5900, depending on whether the policy decision is due to a request that originates from a PEP at the current PDP level.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures.

When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the policy decision points 310-350 in FIGS. 3-4 each processing the content in various possible ways. It does not necessarily need to be one system used by all end users. Accordingly, the appended claims and their legal equivalents should only define the invention, rather than any specific examples given.

We claim:

1. A method for efficient management of hierarchically administered spectrum resources in a communications network, comprising:
receiving a request for a policy decision from a policy enforcement point at a current policy decision point level in a hierarchy of policy decision points;
determining whether the request can be satisfied at the current policy decision point level, wherein if the request cannot be satisfied at the current policy decision point level, forwarding the request to a policy decision point at a policy decision point level that is higher in the hierarchy, otherwise
retrieving policy information from a policy database;
determining a policy decision, wherein if the request was received from the policy enforcement point at the current policy decision point hierarchy level, sending the policy decision to the policy enforcement point at the current policy decision point level in the hierarchy, otherwise,
sending the policy decision to a policy decision point level lower in the hierarchy.

2. The method of claim 1, further comprising:
receiving policy updates from policy decision points higher in the hierarchy.

3. The method of claim 1, wherein policy decisions are determined based on user profiles.

4. The method of claim 1, wherein the hierarchy of policy decision points corresponds to a hierarchy of communications spectrum blocks.

5. The method of claim 4, wherein each spectrum block in the hierarchy has an associated policy decision point.

6. The method of claim 5, wherein the policy decision point associated with each spectrum block governs the allocation of resources for each corresponding spectrum block.

7. The method of claim 1, wherein the communications network is a cognitive radio network.

8. An apparatus that provides efficient spectrum management of a communications network, comprising:
a policy database; and
a policy decision point that receives a request for a policy decision from a policy enforcement point at a current policy decision point level in a hierarchy of policy decision points, determines whether the request can be satisfied at the current policy decision point level, wherein if the request cannot be satisfied at the current policy decision point level, the policy decision point forwards the request to a policy decision point at a policy decision point level that is higher in the hierarchy, otherwise the policy decision point retrieves policy information from the policy database, determines a policy decision, wherein if the request was received from the policy enforcement point at the current policy decision point hierarchy level, the policy decision point sends the policy decision to the policy enforcement point at the current policy decision point level in the hierarchy, otherwise, the policy decision point sends the policy decision to a policy decision point level lower in the hierarchy.

9. The apparatus of claim 8, wherein the policy decision point receives policy updates from policy decision points higher in the hierarchy.

10. The apparatus of claim 8, wherein the policy decision point determines policy decisions based on user profiles.

11. The apparatus of claim 8, wherein the hierarchy of policy decision points corresponds to a hierarchy of communications spectrum blocks.

12. The apparatus of claim 11, wherein each spectrum block in the hierarchy has an associated policy decision point.

13. The apparatus of claim 12, wherein the policy decision point associated with each spectrum block governs the allocation of resources for each corresponding spectrum block.

14. The apparatus of claim 8, wherein the communications network is a cognitive radio network.

15. A cognitive radio device, comprising:
a policy database; and
a policy decision point that receives a request for a policy decision from a policy enforcement point at a current policy decision point level in a hierarchy of policy decision points, determines whether the request can be satisfied at the current policy decision point level, wherein if the request cannot be satisfied at the current policy decision point level, the policy decision point forwards the request to a policy decision point at a policy decision point level that is higher in the hierarchy, otherwise the policy decision point retrieves policy information from the policy database, determines a policy decision, wherein if the request was received from the policy enforcement point at the current policy decision point hierarchy level, the policy decision point sends the policy decision to the policy enforcement point at the current policy decision point level in the hierarchy, otherwise, the policy decision point sends the policy decision to a policy decision point level lower in the hierarchy.

16. The cognitive radio device of claim 15, wherein the policy decision point receives policy updates from policy decision points higher in the hierarchy.

17. The cognitive radio device of claim 15, wherein the policy decision point determines policy decisions based on user profiles.

18. The cognitive radio device of claim 15, wherein the hierarchy of policy decision points corresponds to a hierarchy of communications spectrum blocks.

19. The cognitive radio device of claim 18, wherein each spectrum block in the hierarchy has an associated policy decision point.

20. The cognitive radio device of claim 19, wherein the policy decision point associated with each spectrum block governs the allocation of resources for each corresponding spectrum block.
